(19) United States
(12) Patent Application Publication
(10) Pub. No.: US 2023/0243878 A1
(43) Pub. Date: Aug. 3, 2023

(54) COMPUTER-READABLE RECORDING MEDIUM STORING PROGRAM, INFORMATION PROCESSING APPARATUS, AND OBTAINMENT METHOD OF CONDUCTOR LOSS AND DIELECTRIC LOSS

(71) Applicant: Fujitsu Limited, Kawasaki-shi (JP)

(72) Inventor: Taiga FUKUMORI, Isehara (JP)

(73) Assignee: Fujitsu Limited, Kawasaki-shi (JP)

(21) Appl. No.: 17/983,547

(22) Filed: Nov. 9, 2022

(30) Foreign Application Priority Data
Feb. 1, 2022 (JP) 2022-14550

(51) Int. Cl. G01R 27/26

(52) U.S. Cl. CPC G01R 27/2694

(57) ABSTRACT

A process includes reading a measurement result of a sum of a conductor loss and a dielectric loss for a signal at a predetermined frequency in each of first wiring-boards, respective wiring-widths and insulating-layer-thicknesses of the first wiring-boards being different, and an analysis result by three-dimensional electromagnetic field analysis of conductivity dependence of the conductor loss and the dielectric loss in each of second wiring-boards including same wiring-widths and insulating-layer-thicknesses as the wiring-widths and the insulating-layer-thicknesses of the first wiring-boards, obtaining a first ratio of conductor losses and a second ratio of dielectric losses between two second wiring-boards among the second wiring-boards, based on the analysis result, and obtaining a value of the conductor loss and a value of the dielectric loss for each of two first wiring-boards corresponding to the two second wiring-boards among the first wiring-boards, based on the first ratio, the second ratio, and the measurement result.

### CROSS-REFERENCE TO RELATED APPLICATION

This application is based upon and claims the benefit of priority of the prior Japanese Patent Application No. 2022-14550, filed on Feb. 1, 2022, the entire contents of which are incorporated herein by reference.

### FIELD

The embodiments discussed herein are related to a computer-readable recording medium storing a program, an information processing apparatus, and an obtainment method of a conductor loss and a dielectric loss.

### BACKGROUND

There is a transmission path, through which a signal having a high frequency exceeding several hundreds MHz propagates, between a plurality of processors, between a processor and a memory, and the like. A simulation tool for calculating a loss in a case where a signal is transmitted through such a transmission path and determining whether or not the signal transmission is possible is known.

For a wiring board such as a printed board, there is a method of calculating a value of a plurality of types of losses such as a loss derived from a conductive material (conductor loss), a loss derived from an insulating material (dielectric loss), and a loss derived from a structure of a coupling portion such as a via portion, based on parameters and dimensions of prepared materials.

In a case where the conductor loss is calculated by such a method, in addition to dimensions of the conductive material of the wiring board, a conductivity σ of the conductive material is used as a parameter. In a case where the dielectric loss is calculated, in addition to dimensions of the conductive material and the insulating material, a dielectric constant Dk and a dielectric loss tangent Df of the insulating material are used as parameters. In a case where the loss of the structure of the coupling portion such as the via portion is calculated, dimensional information and parameters of σ, Dk, and Df are used in the same manner as described above.

As for σ, values for flat metals are obtained from, for example, a scientific table or the like. In a case of copper that is often used for the printed board, σ=5.8×10⁷ (S/m). Dk and Df are measured by using a resonator or the like. For example, Dk=4.0, Df=0.01, and the like are measured at a frequency of 1 GHz for each insulating material of the printed board. A manufacturer of the printed board materials may provide these measurement values of Dk and Df.

A method of directly measuring a transmission loss of a wiring board having desired dimensions by using a measurement apparatus such as a vector network analyzer is known. In the related art, there is a method of obtaining a sum of a conductor loss and a dielectric loss by measuring transmission losses of two or more types of wiring boards having different wiring lengths and terminal resistances and performing de-embedding processing to remove a loss or the like derived from a structure of a coupling portion such as a via portion.

Japanese Laid-open Patent Publication No. 2009-093327 is disclosed as related art.

### SUMMARY

According to an aspect of the embodiments, a non-transitory computer-readable recording medium storing a program causing a computer to execute a process, the process includes reading, from a memory, a measurement result of a sum of a conductor loss and a dielectric loss for a signal at a predetermined frequency in each of a plurality of first wiring boards, respective wiring widths and insulating layer thicknesses of the plurality of first wiring boards being different, and an analysis result by three-dimensional electromagnetic field analysis of conductivity dependence of the conductor loss and the dielectric loss in each of a plurality of second wiring boards that include same wiring widths and insulating layer thicknesses as the wiring widths and the insulating layer thicknesses of the plurality of first wiring boards, obtaining a first ratio of conductor losses and a second ratio of dielectric losses between two second wiring boards among the plurality of second wiring boards, based on the analysis result, and obtaining a first value of the conductor loss and a second value of the dielectric loss for each of two first wiring boards that correspond to the two second wiring boards among the plurality of first wiring boards, based on the first ratio, the second ratio, and the measurement result.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating examples of an information processing apparatus and a calculation method of a conductor loss and a dielectric loss of a first embodiment;

FIG. 2 is a graph illustrating an example of isolation of a conductor loss and a dielectric loss in a case where parameters have no frequency dependence;

FIG. 3 is a graph illustrating an example of an actual measurement value and a calculated value of frequency dependence of a transmission loss;

FIG. 4 is a graph illustrating an example of an actual measurement value and a calculated value of frequency dependence of a transmission loss after a design change;

FIG. 5 is a block diagram illustrating an example of hardware of an information processing apparatus according to a second embodiment;

FIG. 6 is a block diagram illustrating an example of functions of the information processing apparatus;

FIG. 7 is a diagram illustrating an example of a measurement apparatus;

FIG. 8 is a sectional view of an example of a wiring board;

FIG. 9 is a graph illustrating an example of isolation of a sum of a conductor loss and a dielectric loss and the other losses;

FIG. 10 is a diagram illustrating an example of a measurement result for two wiring boards having different wiring widths and insulating layer thicknesses;

FIG. 11 is a diagram illustrating an example of an analysis result of a dependence of a conductor loss and a dielectric loss for two wiring boards;

FIG. 12 is a diagram illustrating an example of a calculation result of a ratio of conductor losses and a ratio of dielectric losses;

FIG. 13 is a graph illustrating a determination example of σ;

FIG. 14 is a diagram illustrating a determination example of Df; and

FIG. 15 is a flowchart for describing an example of a flow of processing of a calculation method of a conductor loss and a dielectric loss.

### DESCRIPTION OF EMBODIMENTS

Among parameters used for calculating a transmission loss, there is a parameter having frequency dependence. In a case where such a parameter is determined, the parameter may be adjusted by using a wiring board having specific dimensions such that an actual measurement value and a calculated value by a simulation tool for the frequency dependence of the transmission loss coincide with each other. However, in a case where a wiring width or an insulating layer thickness in the wiring board is changed due to a design change or the like, the value of the parameter is also changed in some cases. The value of the parameter may also vary depending on manufacturing conditions of the wiring board (for example, a degree of roughening a front surface of a conductor for improving adhesion). For this reason, it is difficult to determine the values of the parameters, and it is difficult to calculate the value of each of the conductor loss and the dielectric loss from the parameters.

Hereinafter, embodiments of techniques capable of calculating a value of each of a conductor loss and a dielectric loss of a wiring board will be described with reference to the drawings.

### First Embodiment

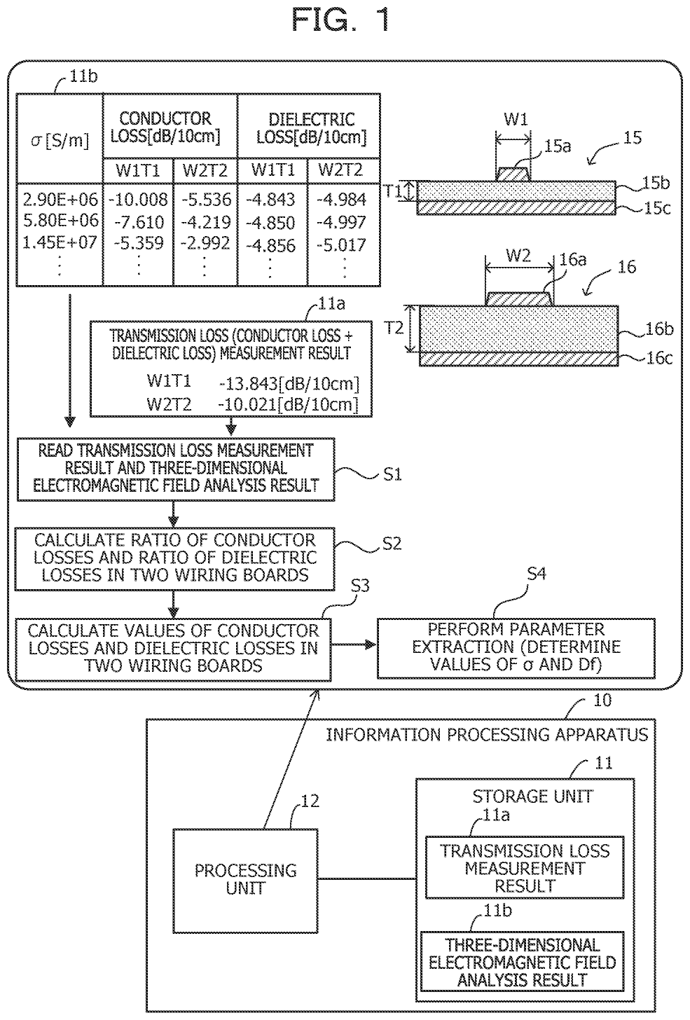

FIG. 1 is a diagram illustrating examples of an information processing apparatus and a calculation method of a conductor loss and a dielectric loss of a first embodiment.

For example, an information processing apparatus 10 of the first embodiment calculates a value of each of a conductor loss and a dielectric loss of a transmission loss in a wiring board such as a printed board, and determines σ and Df from the calculated value of each of conductor loss and dielectric loss.

The information processing apparatus 10 includes a storage unit 11, and a processing unit 12. The storage unit 11 is a volatile storage device such as a random-access memory (RAM) or a non-volatile storage device such as a hard disk drive (HDD) or a flash memory, for example.

The storage unit 11 stores a transmission loss measurement result 11a, and a three-dimensional electromagnetic field analysis result 11b. The transmission loss measurement result 11a is a measurement result of a sum of the conductor loss and the dielectric loss for a signal at a predetermined frequency in each of a plurality of wiring boards having different wiring widths and insulating layer thicknesses. The sum of the conductor loss and the dielectric loss is obtained by removing a loss or the like derived from a structure of a coupling portion such as a via portion of the wiring board by a de-embedding processing or the like from the measured entire transmission loss.

FIG. 1 illustrates sectional shapes of parts of two wiring boards 15 and 16 that are measurement targets, For example, the wiring boards 15 and 16 each include a microstrip line as a transmission line. In the wiring boards 15 and 16, wiring patterns 15a and 16a made of a conductive material are formed on front surfaces of insulating layers 15b and 16b, and ground planes 15c and 16c are formed on rear surfaces of the insulating layers 15b and 16b, respectively. The wiring width of the wiring board 15 is W1, and the wiring width of the wiring board 16 is W2 (>W1). The insulating layer thickness of the wiring board 15 is T1, and the insulating layer thickness of the wiring board 16 is T2 (>T1).

FIG. 1 illustrates an example of the transmission loss measurement result 11a for the wiring boards 15 and 16. In the example of the transmission loss measurement result 11a in FIG. 1, the wiring board 15 is denoted as “W1T1”, and the wiring board 16 is denoted as “W2T2”. In the example of FIG. 1, the measurement result for the wiring board 15 is −13.843 [dB/10 cm], and the measurement result for the wiring board 16 is −10.021 [dB/10 cm]. A specific example of a measurement method of a sum of a conductor loss and a dielectric loss will be described later.

The three-dimensional electromagnetic field analysis result 11b is a result of three-dimensional electromagnetic field analysis of σ dependence of the conductor loss and the dielectric loss for a signal at a predetermined frequency in each of a plurality of wiring boards having the same wiring widths and insulating layer thicknesses as those of the plurality of wiring boards that are the measurement target above.

The three-dimensional electromagnetic field analysis may be performed by using various three-dimensional electromagnetic field analysis simulators. Analysis conditions of the three-dimensional electromagnetic field analysis include, for example, Dk obtained by the measurement, a temporary value of Df (for example, 0.01), a range of σ to be changed, and a frequency of a signal to be transmitted through the wiring in addition to dimensions such as the wiring width and the insulating layer thickness of the plurality of wiring boards used for the measurement above. For example, in a case where the conductive material in the wiring board is copper, since σ in ideal copper is 5.8×10⁷ [S/m], the range of σ is set to 1.0×10⁶ to 1.0×10⁸ [S/m]. The range of σ may be changed as appropriate depending on the conductive material. In a case where the value of σ is predictable in advance, a range around the predicted value of σ may be set as the range of σ.

FIG. 1 illustrates an example of the three-dimensional electromagnetic field analysis result 11b for two wiring boards (denoted as “W1T1” and “W2T2”) having the same wiring widths and insulating layer thicknesses as those of the wiring boards 15 and 16.

By the three-dimensional electromagnetic field analysis, it is possible to calculate the value of each of the conductor loss and the dielectric loss in accordance with each value of σ. In the example of FIG. 1, the analysis results of the conductor loss and the dielectric loss of the wiring boards 15 and 16 in a case where σ is changed to 2.90 E+06 [S/m], 5.80 E+06 [S/m], 1.45 E+07 [S/m], and the like are illustrated. For example, in a case where σ=2.90 E+06, the conductor loss of “W1T1” is −10.008 [dB/10 cm], and the conductor loss of “W2T2” is −5.536 [dB/10 cm]. In this case, the dielectric loss of “W1T1” is −4.843 [dB/10 cm], and the dielectric loss of “W2T2” is −4.984 [dB/10 cm].

The three-dimensional electromagnetic field analysis may be performed by the processing unit 12 of the information processing apparatus 10 executing the three-dimensional electromagnetic field analysis simulator, or may be performed by an information processing apparatus different from the information processing apparatus 10. In the latter case, the information processing apparatus 10 acquires the analysis result of the three-dimensional electromagnetic field analysis performed by another information processing apparatus, and stores the analysis result in the storage unit 11 as the three-dimensional electromagnetic field analysis result 11b. As described above, the storage unit 11 may store each of the transmission loss measurement result 11a and the three-dimensional electromagnetic field analysis result 11b for a plurality of frequencies.

For example, the processing unit 12 may be realized by a processor that is hardware such as a central processing unit (CPU), a graphics processing unit (GPU), or a digital signal processor (DSP). However, the processing unit 12 may include an electronic circuit such as an application-specific integrated circuit (ASIC) or a field-programmable gate array (FPGA). The processor executes a program stored in a memory such as a RAM. For example, a program for causing the information processing apparatus 10 to perform processing of operations S1 to S4 described below is executed. A set of a plurality of processors may be referred to as a “multiprocessor” or simply a “processor”.

Hereinafter, a flow of the outline of the calculation method of the conductor loss and the dielectric loss by the information processing apparatus 10 will be described. The processing unit 12 reads the above-described transmission loss measurement result 11a and the above-described three-dimensional electromagnetic field analysis result 11b for the predetermined frequency from the storage unit 11 (operation S1).

Based on the three-dimensional electromagnetic field analysis result 11b, the processing unit 12 calculates the ratio of the conductor losses in two wiring boards among the plurality of wiring boards, and the ratio of the dielectric losses in the two wiring boards (operation S2).

In a case where the three-dimensional electromagnetic field analysis result 11b is obtained as in the example of FIG. 1, the ratio of the conductor losses and the ratio of the dielectric losses in both wiring boards of “W1T1” and “W2T2” are calculated. In a case where there is a variation in the calculated ratio depending on the value of σ, the processing unit 12 may calculate an average value of the ratios of the conductor losses or the dielectric losses at respective values of σ.

Based on the calculated ratio of the conductor losses, the calculated ratio of the dielectric losses, and the transmission loss measurement result 11a, the processing unit 12 calculates the value of the conductor loss and the value of the dielectric loss for each of the wiring boards 15 and 16 (operation S3).

For the wiring board 16, the value of the conductor loss is x, the value of the dielectric loss is y, the ratio of the conductor losses is r₁, and the ratio of the dielectric losses is r₂. In this case, a sum Lossₐ of the conductor loss and the dielectric loss measured for the wiring board 16 and a sum Loss_{b} of the conductor loss and the dielectric loss measured for the wiring board 15 may be represented by simultaneous equations such as Equation (1) below.

$$\{ \begin{matrix}x + y = {Loss}_{a} \\ {r}_{1} x + {r}_{2} y = {Loss}_{b}\end{matrix} \qquad ( 1 )$$

Accordingly, the processing unit 12 may calculate the value (x) of the conductor loss and the value (y) of the dielectric loss in the wiring board 16 by solving the simultaneous equations of Equation (1). The processing unit 12 may calculate the value (r₁x) of the conductor loss and the value (r₂y) of the dielectric loss in the wiring board 15.

The processing unit 12 may display the calculated values of the conductor loss and the dielectric loss of the wiring boards 15 and 16 on a display device (not illustrated). The processing unit 12 may store the calculated values of the conductor loss and the dielectric loss of the wiring boards 15 and 16 in the storage unit 11.

In a case where there are three or more wiring boards having different wiring widths and insulating layer thicknesses, it is possible to calculate the value of each of the conductor loss and the dielectric loss for each wiring board by selecting two wiring boards at a time, calculating the ratios as described above, and solving the simultaneous equations represented by Equation (1).

Based on the calculation results of the value of the conductor loss and the value of the dielectric loss, the processing unit 12 performs parameter extraction (determination of the values of σ and Df) (operation S4). Based on the three-dimensional electromagnetic field analysis result 11b, the processing unit 12 determines the value of σ corresponding to the calculation result of the value of the conductor loss. Based on the three-dimensional electromagnetic field analysis result 11b, the processing unit 12 obtains the value (analysis value) of the dielectric loss corresponding to the determined value of σ. Based on the ratio between the analysis value and the calculation result of the value of the dielectric loss calculated in the processing in operation S3, the processing unit 12 determines the value of Df. A specific example of a method of determining σ and Df will be described later.

Here, in a case where there is a variation in the values of σ and Df determined for each wiring board, the processing unit 12 may determine, as the value of each of σ and Df, an average value of the values of each of σ and Df for the respective wiring boards. The processing unit 12 may display the determined value of each parameter on the display device (not illustrated). The processing unit 12 may store the determined value of each parameter in the storage unit 11

As described above, the information processing apparatus 10 stores the transmission loss measurement result 11a and the three-dimensional electromagnetic field analysis result 11b for a signal at a predetermined frequency in each of the plurality of wiring boards having different wiring widths and insulating layer thicknesses. Based on the three-dimensional electromagnetic field analysis result 11b, the information processing apparatus 10 calculates the ratio of the conductor losses and the ratio of the dielectric losses in the wiring boards 15 and 16. Based on these ratios and the transmission loss measurement result 11a, the information processing apparatus 10 calculates the value of the conductor loss and the value of the dielectric loss for each of the wiring boards 15 and 16.

As described above, with the information processing apparatus 10 of the first embodiment, it is possible to calculate the value of each of the conductor loss and the dielectric loss of the wiring boards 15 and 16. Assuming that the parameters (σ, Dk, and Df) have no frequency dependence, the isolation of the conductor loss and the dielectric loss in the transmission loss may be performed without using the calculation method of the conductor loss and the dielectric loss described above.

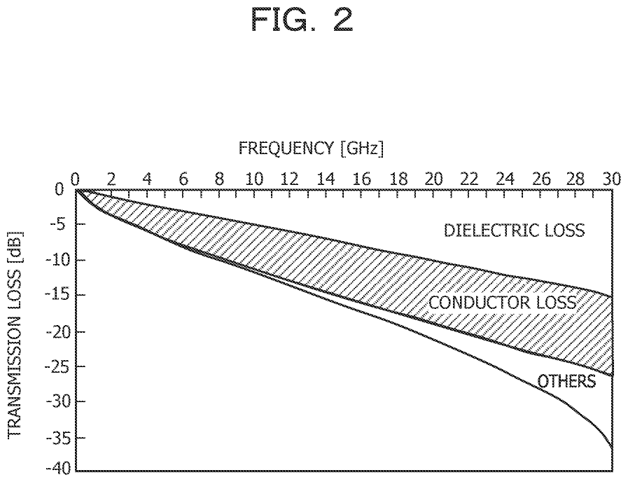

FIG. 2 is a graph illustrating an example of the isolation of the conductor loss and the dielectric loss in a case where parameters have no frequency dependence. The vertical axis represents a value [dB] of the transmission loss, and the horizontal axis represents a frequency [GHz] of the signal transmitted through the wiring board.

In a case where σ, Dk, and Df have no frequency dependence, the dielectric loss is proportional to the square root of σ and the square root of the frequency, and the conductor loss is proportional to the square root of Dk, Df, and the frequency. For this reason, as illustrated in FIG. 2, it is possible to isolate the conductor loss, the dielectric loss, and the other losses at each frequency. However, in a case where σ, Dk, and Df have frequency dependence, it is difficult to isolate the conductor loss and the dielectric loss.

In the information processing apparatus 10 of the first embodiment, even in a case where σ, Dk, and Df have frequency dependence, it is possible to isolate the conductor loss and the dielectric loss based on the transmission loss measurement result 11a and the three-dimensional electromagnetic field analysis result 11b for a signal at a predetermined frequency.

With the information processing apparatus 10 of the first embodiment, the necessity of adjusting the parameters such that the actual measurement value and the calculated value by the simulation tool for the frequency dependence of the transmission loss coincide with each other in order to determine the parameters is omitted.

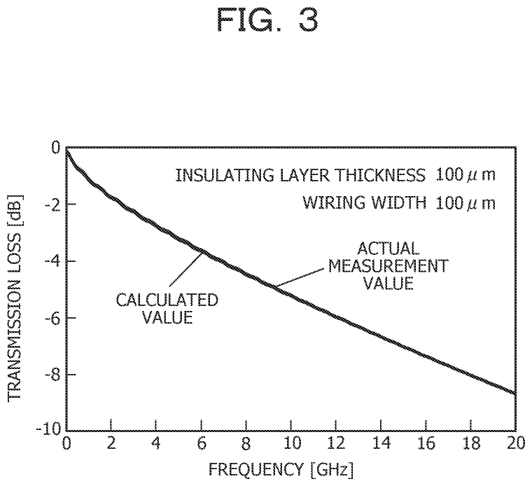

FIG. 3 is a graph illustrating an example of the actual measurement value and the calculated value of the frequency dependence of the transmission loss. The vertical axis represents a value [dB] of the transmission loss, and the horizontal axis represents a frequency [GHz] of the signal transmitted through the wiring board. FIG. 3 illustrates an example in which parameters for the frequency dependence of the transmission loss are adjusted for a certain wiring board having an insulating layer thickness and a wiring width of 100 μm. As illustrated in FIG. 3, the actual measurement value and the calculated value substantially coincide with each other.

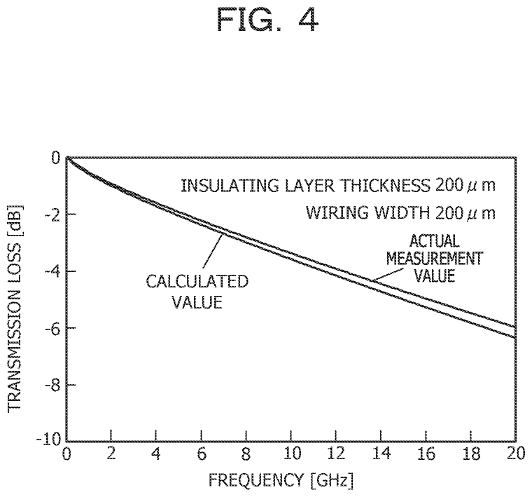

FIG. 4 is a graph illustrating an example of the actual measurement value and the calculated value of the frequency dependence of the transmission loss after a design change. In FIG. 4, the insulating layer thickness and the wiring width of the wiring board are changed to 200 μm. In a case where a design change is made in this manner, a difference from the actual measurement value is caused even in a case of using the parameters obtained before the design change for calculation. In order to obtain appropriate parameters, the parameters are adjusted again for the wiring board after the design change. With the information processing apparatus 10 of the first embodiment, such labor may be omitted.

Dk and Df are changed by about 10% depending on heating and application of force at the time of lamination in the manufacturing of the wiring board. For example, even in a case where the measurement result of Dk=4.0 is obtained in the measurement of an insulating material alone, variation of about Dk=3.6 to 4.4 may occur in a case where the insulating material is used as the insulating layer of the wiring board. In the manufacturing of the wiring board, in order to obtain adhesion to the insulating layer, it is common to roughen a front surface of a conductor so as to have unevenness, and effective o of copper at the time of high-frequency transmission has a value smaller than 5.8×10⁷ (S/m). Since the value of σ varies depending on the frequency, it is generally difficult to measure σ. Since the roughening method of the front surface of the conductor differs depending on the vendor that manufactures the wiring board, the difference in σ depending on the roughening method is also large. As described above, it is difficult to obtain an actual value of the parameter in the wiring board, for example, a general value of σ.

With the information processing apparatus 10 of the first embodiment, σ and Df are not directly measured. σ is calculated from the conductor loss calculated based on the transmission loss measurement result 11a for the wiring boards 15 and 16 and the three-dimensional electromagnetic field analysis result 11b for two wiring boards having the same wiring width and insulating layer thickness as those of the wiring boards 15 and 16. Df is calculated based on the dielectric loss calculated based on the transmission loss measurement result 11a and the three-dimensional electromagnetic field analysis result 11b described above, and the calculated σ.

For this reason, by using, as the wiring boards 15 and 16, wiring boards manufactured with the same specifications as those of the actual product or wiring boards manufactured by the same vendor as that of the actual product, it is possible to obtain parameters corresponding to the actual product.

Accordingly, even in a case where a design change is made, by using these parameters, it is possible to accurately calculate the conductor loss and the dielectric loss without re-manufacturing the wiring board according to the design change and performing the measurement of the transmission loss, the adjustment of the parameters, or the like.

### Second Embodiment

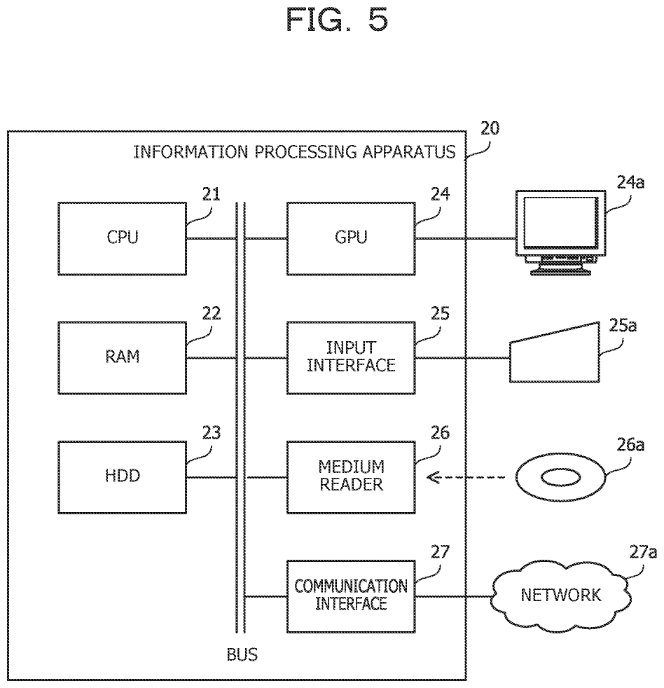

Next, a second embodiment will be described. FIG. 5 is a block diagram illustrating an example of hardware of an information processing apparatus.

An information processing apparatus 20 may be implemented by a computer as illustrated in FIG. 5. The information processing apparatus 20 includes a CPU 21, a RAM 22, an HDD 23, a GPU 24, an input interface 25, a medium reader 26, and a communication interface 27. The above units are coupled to a bus.

The CPU 21 is a processor including an arithmetic circuit that executes program commands. The CPU 21 loads at least a part of a program and data stored in the HDD 23 into the RAM 22, and executes the program. The CPU 21 may include a plurality of processor cores, or the information processing apparatus 20 may include a plurality of processors, and processing to be described below may be executed in parallel by using the plurality of processors or processor cores. A set of a plurality of processors (multiprocessor) may be referred to as a “processor”.

The RAM 22 is a volatile semiconductor memory that temporarily stores a program executed by the CPU 21 or data used for computation by the CPU 21. The information processing apparatus 20 may include a type of memory other than the RAM, and may include a plurality of memories.

The HDD 23 is a non-volatile storage device that stores a program of software such as an operating system (OS), middleware, and application software, and data. Examples of the program include a program for causing the information processing apparatus 20 to execute processing of calculating a conductor loss and a dielectric loss of a wiring board. The information processing apparatus 20 may include other types of storage devices such as a flash memory and a solid-state drive (SSD), and may include a plurality of non-volatile storage devices.

The GPU 24 outputs an image to a display 24a coupled to the information processing apparatus 20 in accordance with a command from the CPU 21. As the display 24a, a cathode ray tube (CRT) display, a liquid crystal display (LCD), a plasma display panel (PDP), an organic electro-luminescence (OEL) display, or the like may be used.

The input interface 25 acquires an input signal from an input device 25a coupled to the information processing apparatus 20, and outputs the input signal to the CPU 21. As the input device 25a, a pointing device such as a mouse, a touch panel, a touchpad, or a trackball, a keyboard, a remote controller, a button switch, or the like may be used. A plurality of types of input devices may be coupled to the information processing apparatus 20.

The medium reader 26 is a reading device that reads a program or data recorded on a recording medium 26a. As the recording medium 26a, for example, a magnetic disk, an optical disk, a magneto-optical (MO) disk, a semiconductor memory, or the like may be used. The magnetic disk includes a flexible disk (FD) and an HDD. The optical disk includes a compact disc (CD) and a Digital Versatile Disc (DVD).

For example, the medium reader 26 copies a program or data read from the recording medium 26a to another recording medium such as the RAM 22 or the HDD 23. For example, the read program is executed by the CPU 21. The recording medium 26a may be a portable type recording medium, and may be used to distribute a program or data. The recording medium 26a and the HDD 23 may be referred to as a computer-readable recording medium.

The communication interface 27 is an interface that is coupled to a network 27a and that performs communication with another information processing apparatus through the network 27a. The communication interface 27 may be a wired communication interface coupled to a communication device such as a switch through a cable, or may be a wireless communication interface coupled to a base station through a wireless link.

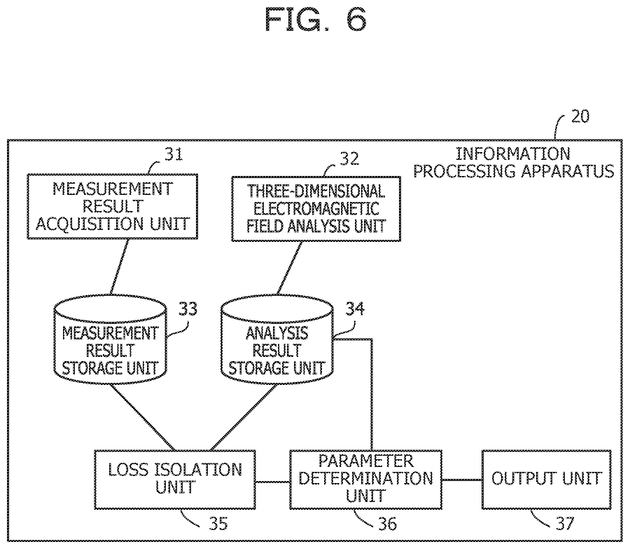

Next, functions of the information processing apparatus 20 will be described. FIG. 6 is a block diagram illustrating an example of functions of the information processing apparatus. The information processing apparatus 20 includes a measurement result acquisition unit 31, a three-dimensional electromagnetic field analysis unit 32, a measurement result storage unit 33, an analysis result storage unit 34, a loss isolation unit 35, a parameter determination unit 36, and an output unit 37. For example, the measurement result storage unit 33 and the analysis result storage unit 34 may be implemented by using a storage area allocated in the RAM 22 or the HDD 23. The measurement result acquisition unit 31, the three-dimensional electromagnetic field analysis unit 32, the loss isolation unit 35, the parameter determination unit 36, and the output unit 37 may be implemented by using, for example, a program module executed by the CPU 21, and are examples of functions executed by the processing unit 12 illustrated in FIG. 1.

The measurement result acquisition unit 31 acquires a measurement result of the sum of the conductor loss and the dielectric loss for a signal at a predetermined frequency in each of a plurality of wiring boards having different wiring widths and insulating layer thicknesses. The measurement result corresponds to the transmission loss measurement result 11a illustrated in FIG. 1. The measurement result acquisition unit 31 may acquire a measurement result of the sum of the conductor loss and the dielectric loss for signals at a plurality of frequencies.

The three-dimensional electromagnetic field analysis unit 32 performs a three-dimensional electromagnetic field analysis of σ dependence of the conductor loss and the dielectric loss for a signal at a predetermined frequency in each of a plurality of wiring boards having the same wiring widths and insulating layer thicknesses as those of the plurality of wiring boards described above. The three-dimensional electromagnetic field analysis may be performed by an information processing apparatus different from the information processing apparatus 20.

The measurement result storage unit 33 stores the measurement result of the sum of the conductor loss and the dielectric loss.

The analysis result storage unit 34 stores an analysis result (corresponding to the three-dimensional electromagnetic field analysis result 11b in FIG. 1) of the three-dimensional electromagnetic field analysis.

Based on the measurement result and the analysis result described above, the loss isolation unit 35 performs isolation of the conductor loss and the dielectric loss (calculates the respective values).

Based on the calculated values of the conductor loss and the dielectric loss, and the analysis result, the parameter determination unit 36 determines the values of σ and Df.

The output unit 37 outputs the calculated values of the conductor loss and the dielectric loss, and the determined values of the parameters. The output unit 37 may output and display these values on the display 24a, or may output and store these values in the HDD 23. The output unit 37 may transmit these values to another information processing apparatus through the network 27a.

### Measurement of Sum of Conductor Loss and Dielectric Loss

Next, an example of the measurement method of the sum of the conductor loss and the dielectric loss will be described. As a measurement apparatus, for example, a vector network analyzer having two or more ports may be used.

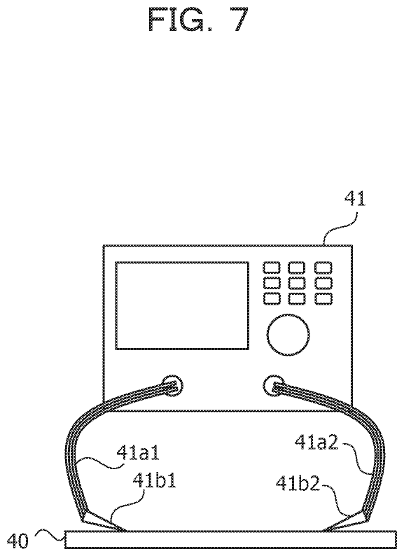

FIG. 7 is a diagram illustrating an example of the measurement apparatus. A measurement apparatus 41 illustrated in FIG. 7 is a two-port vector network analyzer, and performs measurement by bringing probes 41b1 and 41b2 provided at respective distal ends of coaxial cables 41a1 and 41a2 into contact with a wiring board 40.

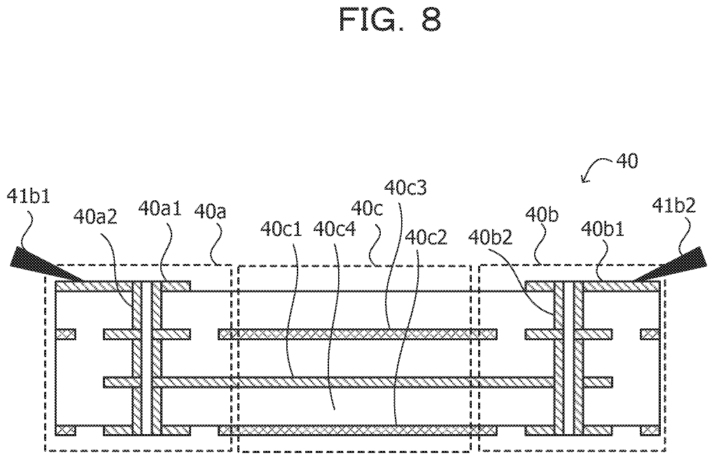

FIG. 8 is a sectional view of an example of the wiring board. The wiring board 40 has portions 40a and 40b in which pads 40a1 and 40b1, vias 40a2 and 40b2, and the like are formed, respectively, and a portion 40c in which a signal wire 40c1 and ground wires 40c2 and 40c3 are formed. An insulating layer 40c4 is provided between the wires,

By bringing the probe 41b1 of the measurement apparatus 41 into contact with the pad 40a1 and bringing the probe 41b2 of the measurement apparatus 41 into contact with the pad 40b1, the transmission loss when a signal is transmitted through the signal wire 40c1 is measured.

Values of S₁₁ and S₂₁ among S parameters are obtained by the measurement by the measurement apparatus 41, but in the present embodiment, S₂₁ is mainly used except for the de-embedding processing. The transmission loss is represented by an amplitude component of S₂₁. As for the determination of Dk, a phase component of S₂₁ is used.

In the de-embedding processing, by measuring the transmission loss for two or more types of wiring boards having different wiring lengths and terminal resistances, the loss due to the portions 40a and 40b is removed from the entire transmission loss, and the loss (the sum of the conductor loss and the dielectric loss) in the portion 40c is obtained. As for the de-embedding processing, various methods such as a short-open-load-thru (SOLT) calibration method and a thru-reflect-line (TRL) calibration method may be used. While there is a method in which the processing may be performed only by the difference in wiring length, there is a method in which termination processing with 50 Ω or infinite Ω (open) is to be performed. A wiring board corresponding to the usable method of the de-embedding processing is used to perform measurement.

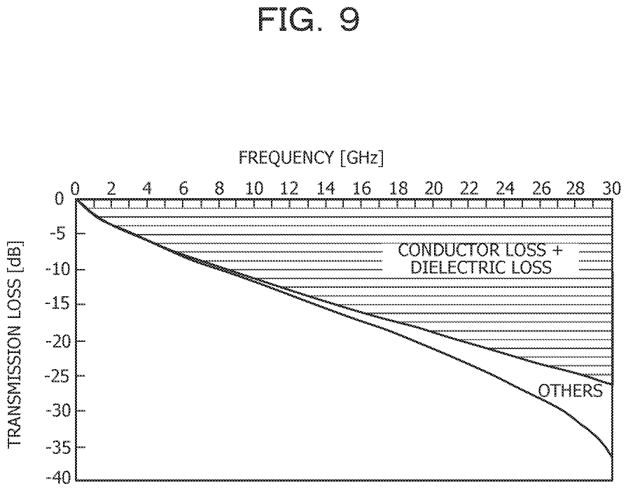

FIG. 9 is a graph illustrating an example of isolation of the sum of the conductor loss and the dielectric loss and the other losses. The vertical axis represents a value [dB] of the transmission loss, and the horizontal axis represents a frequency [GHz] of the signal transmitted through the wiring board.

By the de-embedding processing as described above, it is possible to isolate the sum of the conductor loss and the dielectric loss from the other losses. In order to obtain the measurement results to be used in the calculation method of the conductor loss and the dielectric loss according to the present embodiment, the measurement of S₂₁ is performed on a plurality of wiring boards having different wiring widths and insulating layer thicknesses. For example, the wiring lengths of the plurality of wiring boards are different from each other (for example, 10 cm and 20 cm) in order to perform the de-embedding processing. By the de-embedding processing, the sum of the conductor loss and the dielectric loss is obtained for each of the plurality of wiring boards. Dk is obtained from the phase component of S₂₁ for each of the plurality of wiring boards. In a case where there is a variation in Dk obtained for each of the plurality of wiring boards, an average value thereof may be determined as Dk.

In the wiring board, an electrolytic copper foil may be used as the conductor, but a rolled copper foil may be used. As the insulating material used for the insulating layer, arbitrary wiring board material may be used. A pressure, a temperature, a roughening method of the front surface of the conductor, and the like at the time of manufacturing differ depending on the vendor that manufactures the wiring board. For this reason, it is desirable to use a measurement-target wiring board which is manufactured with the same specifications as those of the actual product or manufactured by the same vendor as that of the actual product.

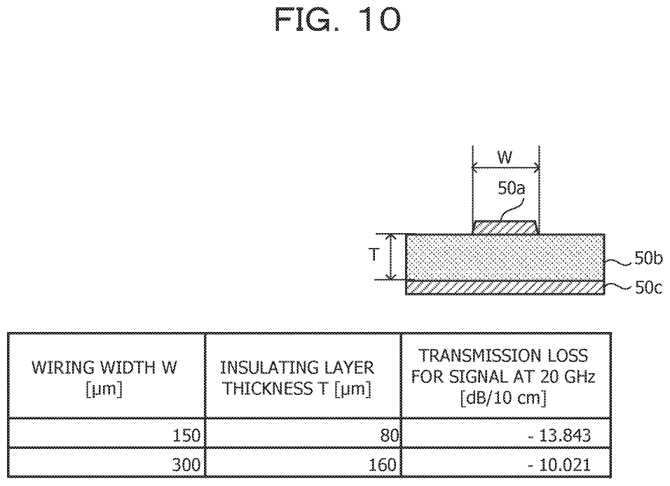

FIG. 10 is a diagram illustrating an example of a measurement result for two wiring boards having different wiring widths and insulating layer thicknesses. Each of the wiring boards includes a microstrip line, A wiring width W is a width of a wiring pattern 50a, and an insulating layer thickness T is a thickness of an insulating layer 50b between the wiring pattern 50a and a ground plane 50c.

In a wiring board with W=150 μm and T=80 μm, the transmission loss (the sum of the conductor loss and the dielectric loss) for a signal at 20 GHz was −13.843 [dB/10 cm], In a wiring board with W=300 μm and T=160 μm, the transmission loss (the sum of the conductor loss and the dielectric loss) for the signal at 20 GHz was −10.021 [dB/10 cm].

W and T are analysis conditions in the three-dimensional electromagnetic field analysis described later. Since W and T vary by about 10% with respect to design values due to manufacturing errors, it is desirable to measure and use finished dimensions of the wiring board on which the measurement is performed.

### Three-Dimensional Electromagnetic Field Analysis

The analysis conditions of the three-dimensional electromagnetic field analysis include Dk obtained by the measurement described above, a temporary value of Df (for example, 0.01), a range of σ to be changed, and a frequency of a signal to be transmitted, in addition to information on dimensions of the plurality of wiring boards used for the measurement described above.

Based on the above-described analysis conditions, the three-dimensional electromagnetic field analysis unit 32 calculates σ dependence of the conductor loss and the dielectric loss for a signal at a predetermined frequency in the plurality of wiring boards having the above-described dimensions by the three-dimensional electromagnetic field analysis.

In the three-dimensional electromagnetic field analysis, it is possible to obtain the conductor loss and the dielectric loss separately. The three-dimensional electromagnetic field analysis unit 32 may obtain the sum of all losses. Although a reflection loss and a radiation loss are also present as other loss factors of the wiring board, it is desirable to design such that these losses are close to zero. In the present embodiment, a case where the reflection loss and the radiation loss are sufficiently small is described as an example. For this reason, in the present embodiment, the sum of the conductor loss and the dielectric loss may be the sum of all the losses.

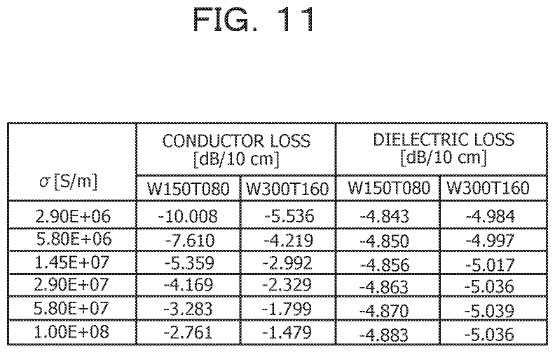

FIG. 11 is a diagram illustrating an example of the analysis result of σ dependence of the conductor loss and the dielectric loss for two wiring boards. An example of FIG. 11 illustrates analysis results of the conductor loss [dB] and the dielectric loss [dB] for two wiring boards when a is changed in a range of 2.90 E+06 [S/m] to 1.00 E+08 [S/m]. “W150T080” represents the wiring board with W=150 μm and T=80 μm illustrated in FIG. 10, and “W300T160” represents the wiring board with W=300 μm and T=160 μm illustrated in FIG. 10. The wiring length is 10 cm, and the temporary value of Df is 0.01. From FIG. 11, it is understood that the conductor loss is largely changed with respect to the change in σ, while the dielectric loss is hardly changed with respect to the change in σ.

### Isolation of Losses

Based on the measurement result and the analysis result described above, the loss isolation unit 35 performs isolation of the conductor loss and the dielectric loss (calculates the respective values) in the following manner.

First, the loss isolation unit 35 calculates a ratio of the conductor losses and a ratio of the dielectric losses in the two wiring boards among a plurality of wiring boards to be analyzed.

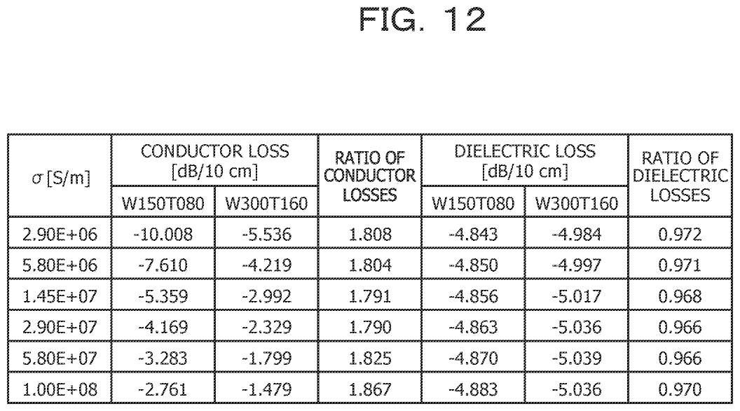

FIG. 12 is a diagram illustrating an example of a calculation result of a ratio of the conductor losses and a ratio of the dielectric losses. The loss isolation unit 35 calculates a ratio of the conductor losses and a ratio of the dielectric losses at each value of σ. In the example illustrated in FIG. 12, the ratio of the conductor losses is about 1.8, the ratio of the dielectric losses is about 0.97, and the values are substantially fixed regardless of the change in σ.

For example, the loss isolation unit 35 may calculate each of the average value of the ratios of the conductor losses and the average value of the ratios of the dielectric losses, and may calculate the value of the conductor loss and the value of the dielectric loss for each of the two wiring boards by Equation (1) above based on the measurement results of the transmission losses.

For example, in a case where the measurement results of the transmission losses of the two wiring boards are represented as illustrated in FIG. 10, Lossₐ=−10.021 [dB/10 cm], and Loss_{b}=−13.843 [dB/10 cm] in Equation (1). In a case where the average value of the ratios of the conductor losses is 1.8 and the average value of the ratios of the dielectric losses is 0.97, r₁=1.8 and r₂=0.97 in Equation (1).

Accordingly, when the simultaneous equations of Equation (1) are solved, x=−4.967 and y=−5.054 are obtained. For example, the conductor loss and the dielectric loss of the wiring board with W=300 μm and T=160 μm are −4.967 [dB/10 cm] and −5.054 [dB/10 cm], respectively. When the average values of the above ratios are used, the conductor loss and the dielectric loss of the wiring board with W=150 μm and T=80 μm are −4.967×1.8=−8.941 [dB/10 cm] and −5.054×0.97=−4.902 [dB/10 cm], respectively. As described above, it is possible to calculate each value of the conductor loss and the dielectric loss for two wiring boards having different W and T.

### Parameter Determination

For example, the parameter determination unit 36 determines the values of σ and Df based on the calculated values of the conductor loss and the dielectric loss and the analysis result in the following manner.

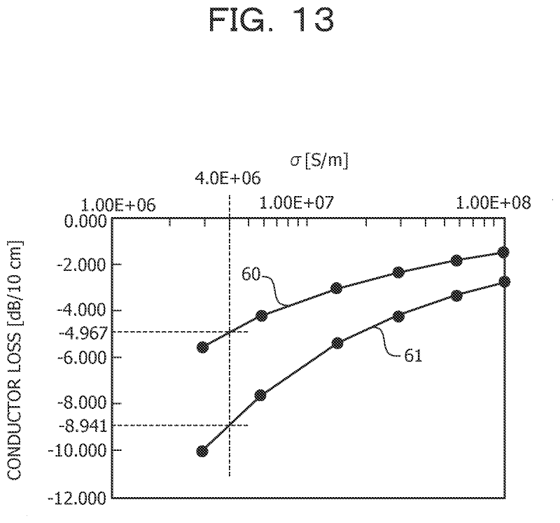

FIG. 13 is a graph illustrating a determination example of σ. The vertical axis represents a value [dB/10 cm] of the conductor loss, and the horizontal axis represents σ [S/m]. FIG. 13 illustrates analysis results of σ dependence of the conductor loss for two wiring boards. An analysis result 60 is an analysis result for the wiring board with W=300 μm and T=160 μm, and an analysis result 61 is an analysis result for the wiring board with W=150 μm and T=80 μm.

The parameter determination unit 36 interpolates a value from the analysis result of σ dependence of the conductor loss to obtain a value of σ corresponding to −4.967 [dB/10 cm] which is the calculation result of the conductor loss of the wiring board with W=300 μm and T=160 μm. In the example illustrated in FIG. 13, a corresponding to −4.967 [dB/10 cm] is 4.0 E+06 [S/m]. Similarly, the parameter determination unit 36 interpolates a value from the analysis result of σ dependence of the conductor loss to obtain a value of σ corresponding to −8.941 [dB/10 cm] which is the calculation result of the conductor loss of the wiring board with W=150 μm and T=80 μm. In the example illustrated in FIG. 13, σ corresponding to −8.941 [dB/10 cm] is 4.0 E+06 [S/m].

In the case of this example, σ obtained for the two wiring boards coincide with each other, but in a case where there is a variation in the values, the parameter determination unit 36 may determine one value of σ by, for example, obtaining an average value of the values of σ. In a case where there are three or more wiring boards, σ may be determined in the same manner.

Alternatively, the parameter determination unit 36 may obtain an approximate formula representing a dependence of the conductor loss for each wiring board from the analysis result of a dependence of the conductor loss, and obtain the value of σ corresponding to the calculation result of the conductor loss based on the approximate formula. Next, the parameter determination unit 36 determines Df.

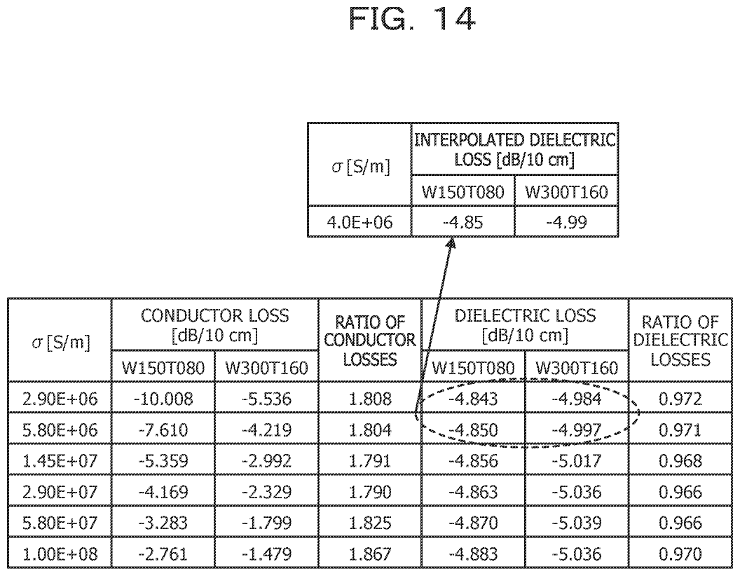

FIG. 14 is a diagram illustrating a determination example of Df. Based on σ dependence of the dielectric loss, the parameter determination unit 36 interpolates a value of the dielectric loss, and obtains the value of the dielectric loss corresponding to the determined σ. In the example illustrated in FIG. 14, the value (interpolation value) of the dielectric loss corresponding to σ=4.0 E+06 [S/m] is −4.85 [dB/10 cm] for the wiring board with W=150 μm and T=80 μm, The value (interpolation value) of the dielectric loss corresponding to σ=4.0 E 06 [S/m] is −4.99 [dB/10 cm] for the wiring board with W=300 μm and T=160 μm.

Since the dielectric loss is proportional to Df, the value of Df to be obtained is obtained from an equation of calculated value of dielectric loss/interpolated value of dielectric loss=value of Df to be obtained/temporary value of Df (value of Df used in three-dimensional electromagnetic field analysis).

In a case where the temporary value of Df is 0.01, the value of Df is obtained from the above equation by multiplying 0.01 by −4.902/−4.85 for the wiring board with W=150 μm and T=80 μm. The value of Df is obtained by multiplying 0.01 by −5.054/−4.99 for the wiring board with W=300 μm and T=160 μm. In this example, the value of Df is 0.01, which is the same as the temporary value.

In a case where there is a variation in the values of Df obtained for the two wiring boards, the parameter determination unit 36 may determine one value of Df by, for example, obtaining the average value of the values of Df. In a case where there are three or more wiring boards, Df may be determined in the same manner.

### Flow of Processing of Calculation Method of Conductor Loss and Dielectric Loss

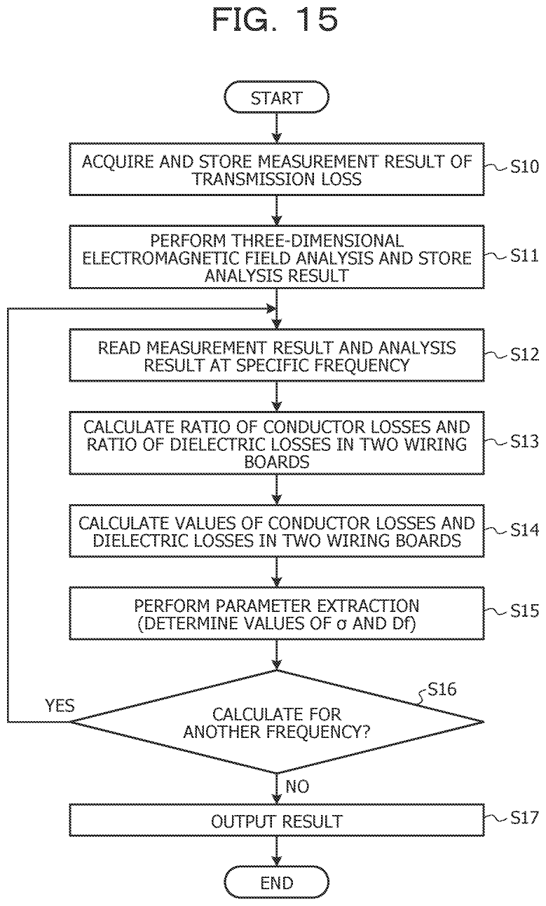

A flow of processing of the calculation method of the conductor loss and the dielectric loss is summarized by using a flowchart. FIG. 15 is a flowchart for describing an example of the flow of the processing of the calculation method of the conductor loss and the dielectric loss.

The measurement result acquisition unit 31 acquires a measurement result (refer to FIG. 10) of the sum of the conductor loss and the dielectric loss for a signal at a predetermined frequency in each of a plurality of wiring boards having different wiring widths and insulating layer thicknesses, and stores the measurement result in the measurement result storage unit 33 (operation S10). The measurement result as illustrated in FIG. 10 may be obtained for a plurality of frequencies.

The three-dimensional electromagnetic field analysis unit 32 performs the three-dimensional electromagnetic field analysis of σ dependence of the conductor loss and the dielectric loss for a signal at a predetermined frequency in each of a plurality of wiring boards having the same wiring widths and insulating layer thicknesses as those of the plurality of wiring boards described above. The three-dimensional electromagnetic field analysis unit 32 stores the analysis result in the analysis result storage unit 34 (operation S11). The three-dimensional electromagnetic field analysis may be performed by an information processing apparatus different from the information processing apparatus 20.

The loss isolation unit 35 reads the measurement result and the analysis result described above from the measurement result storage unit 33 and the analysis result storage unit 34, respectively (operation S12).

Based on the analysis result described above, for example, as illustrated in FIG. 12, the loss isolation unit 35 calculates the ratio of the conductor losses in two wiring boards among the plurality of wiring boards and the ratio of the dielectric losses in the two wiring boards (operation S13).

Based on the calculated ratio of the conductor losses, the calculated ratio of the dielectric losses, and the measurement result of the transmission losses, the loss isolation unit 35 calculates the values of the conductor losses and the values of the dielectric losses of the two wiring boards by using the simultaneous equations of Equation (1) (operation S14).

In a case where there are three or more wiring boards having different wiring widths and insulating layer thicknesses, the loss isolation unit 35 calculates the value of each of the conductor loss and the dielectric loss for each wiring board by selecting two wiring boards at a time, calculating the ratios as described above, and solving the simultaneous equations represented by Equation (1).

Next, based on the calculated values of the conductor loss and the dielectric loss and the analysis result, the parameter determination unit 36 performs parameter extraction (determination of the values of σ and Df) by the processing as described above (operation S15).

The loss isolation unit 35 determines whether or not to calculate the values of the conductor loss and the dielectric loss also for another frequency (operation S16). In a case where it is determined that the values of the conductor loss and the dielectric loss are calculated also for another frequency, the processing from operation S12 is repeated. In a case where it is determined that the values of the conductor loss and the dielectric loss are not calculated for another frequency, the output unit 37 outputs the calculated values of the conductor loss and the dielectric loss, and the determined values of the parameters (operation S17). Accordingly, the processing of the calculation method of the conductor loss and the dielectric loss is ended.

With the information processing apparatus 20 and the calculation method of the conductor loss and the dielectric loss according to the second embodiment described above, the same effects as those of the information processing apparatus 10 and the calculation method of the conductor loss and the dielectric loss according to the first embodiment may be obtained. For example, even in a case where σ, Dk, and Df have frequency dependence, the value of each of the conductor loss and the dielectric loss of the wiring board may be calculated.

The information processing apparatus 20 may determine σ and Dk based on the calculation result of the values of the conductor loss and the dielectric loss. For the calculation of the values of the conductor loss and the dielectric loss, the measurement result of the sums of the conductor loss and the dielectric loss actually measured for a plurality of wiring boards is also used in addition to the analysis result of the three-dimensional electromagnetic field analysis. For this reason, by using as the measurement target the wiring board manufactured with the same specifications as those of the actual product or manufactured by the same vendor as that of the actual product, it is possible to obtain parameters corresponding to the actual product.

Accordingly, even in a case where a design change is made, by using these parameters, it is possible to accurately calculate the conductor loss and the dielectric loss without re-manufacturing the wiring board according to the design change and performing the measurement of the transmission loss, the adjustment of the parameters, or the like.

As described above, the above-described processing content may be realized by causing the information processing apparatus 20 to execute a program. The program may be recorded in a computer-readable recording medium (for example, the recording medium 26a). As the recording medium, for example, a magnetic disk, an optical disk, a magneto-optical disk, a semiconductor memory, or the like may be used. The magnetic disk includes an FD and an HDD. The optical disk includes a CD, a CD-recordable (R)/rewritable (RW), a DVD, and a DVD-R/RW, The program may be recorded in a portable type recording medium and distributed. In this case, the program may be copied from the portable type recording medium to another recording medium (for example, the HDD 23) and executed.

Although the program, the information processing apparatus, and the calculation method of the conductor loss and the dielectric loss of an aspect of the present disclosure have been described above based on the embodiments, these are merely examples and are not limited to the above description.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a program causing a computer to execute a process, the process comprising:
reading, from a memory, a measurement result of a sum of a conductor loss and a dielectric loss for a signal at a predetermined frequency in each of a plurality of first wiring boards, respective wiring widths and insulating layer thicknesses of the plurality of first wiring boards being different, and an analysis result by three-dimensional electromagnetic field analysis of conductivity dependence of the conductor loss and the dielectric loss in each of a plurality of second wiring boards that include same wiring widths and insulating layer thicknesses as the wiring widths and the insulating layer thicknesses of the plurality of first wiring boards;
obtaining a first ratio of conductor losses and a second ratio of dielectric losses between two second wiring boards among the plurality of second wiring boards, based on the analysis result; and
obtaining a first value of the conductor loss and a second value of the dielectric loss for each of two first wiring boards that correspond to the two second wiring boards among the plurality of first wiring boards, based on the first ratio, the second ratio, and the measurement result.

2. The non-transitory computer-readable recording medium according to claim 1, the process further comprising:
determining a third value of conductivity that corresponds to the first value, based on the analysis result.

3. The non-transitory computer-readable recording medium according to claim 2, the process further comprising:
obtaining an analysis value of the dielectric loss that corresponds to the third value, based on the analysis result, and
determining a fourth value of a dielectric loss tangent, based on a ratio between the analysis value and the second value.

4. The non-transitory computer-readable recording medium according to claim 1,
wherein the measurement result and the analysis result for each of signals at a plurality of frequencies are stored in the memory, and
wherein the first value and the second value are obtained for each of the signals at the plurality of frequencies.

5. The non-transitory computer-readable recording medium according to claim 1,
wherein the first value x and the second value y are obtained by simultaneous equations of x+y=Lossₐ and r₁x+r₂y=Loss_{b}, wherein Lossₐ is the measurement result for one of the two first wiring boards, Loss_{b} is the measurement result for the other of the two first wiring boards, r₁ is the first ratio, and r₂ is the second ratio.

6. An information processing apparatus comprising:
a memory configured to store a measurement result of a sum of a conductor loss and a dielectric loss for a signal at a predetermined frequency in each of a plurality of first wiring boards, respective wiring widths and insulating layer thicknesses of the plurality of first wiring boards being different, and an analysis result by three-dimensional electromagnetic field analysis of conductivity dependence of the conductor loss and the dielectric loss in each of a plurality of second wiring boards that include same wiring widths and insulating layer thicknesses as the wiring widths and the insulating layer thicknesses of the plurality of first wiring boards; and
a processor coupled to the memory and configured to:
obtain a first ratio of conductor losses and a second ratio of dielectric losses between two second wiring boards among the plurality of second wiring boards, based on the analysis result; and
obtain a first value of the conductor loss and a second value of the dielectric loss for each of two first wiring boards that correspond to the two second wiring boards among the plurality of first wiring boards, based on the first ratio, the second ratio, and the measurement result.

7. An obtainment method of conductor loss and dielectric loss, the obtainment method comprising:
reading, from a memory, a measurement result of a sum of a conductor loss and a dielectric loss for a signal at a predetermined frequency in each of a plurality of first wiring boards, respective wiring widths and insulating layer thicknesses of the plurality of first wiring boards being different, and an analysis result by three-dimensional electromagnetic field analysis of conductivity dependence of the conductor loss and the dielectric loss in each of a plurality of second wiring boards that include same wiring widths and insulating layer thicknesses as the wiring widths and the insulating layer thicknesses of the plurality of first wiring boards;
obtaining a first ratio of conductor losses and a second ratio of dielectric losses between two second wiring boards among the plurality of second wiring boards, based on the analysis result; and
obtaining a first value of the conductor loss and a second value of the dielectric loss for each of two first wiring boards that correspond to the two second wiring boards among the plurality of first wiring boards, based on the first ratio, the second ratio, and the measurement result, by a processor.
